(19) United States
(12) Patent Application Publication
(10) Pub. No.: US 2013/0241721 A1
(43) Pub. Date: Sep. 19, 2013

(54) DEVICE FOR ACCOMMODATING SENSORS IN A MOTOR VEHICLE

(71) Applicant: GM GLOBAL TECHNOLOGY OPERATIONS LLC, Detroit, MI (US)

(72) Inventor: Markus ARMBRUST, Wonsheim (DE)

(73) Assignee: GM Global Technology Operations LLC, Detroit, MI (US)

(21) Appl. No.: 13/777,151

(22) Filed: Feb. 26, 2013

(30) Foreign Application Priority Data
Mar. 13, 2012 (DE) 10 2012 005 077.1

(51) Int. Cl. G08G 1/16

(52) U.S. Cl. CPC G08G 1/165
USPC 340/435

(57) ABSTRACT

A device for accommodating vehicle sensors and a motor vehicle having such a device are provided. The device includes a sensor, a communication means, a location finding and object detection means, and a housing with an installation space for accommodating the sensor, the communication means, and the location finding and object detection means. The housing is secured to an interior vehicle mirror by a retaining arm. The installation space incorporates an evaluator unit coupled with the sensor, the communication means, and the location finding and object detection means so as to evaluate data from the sensor, the communication means, and the location finding and object detection means.

### CROSS-REFERENCE TO RELATED APPLICATION

This application claims priority to German Patent Application No. 10 2012 005 077.1, filed Mar. 13, 2012, which is incorporated herein by reference in its entirely.

### TECHNICAL FIELD

The technical field pertains to a device for accommodating sensors in a motor vehicle, in particular front sensors, as well as a motor vehicle encompassing such a device.

### BACKGROUND

In order to prevent accidents, conventional motor vehicles are increasingly being equipped with active driver assistance systems, which encompass a plurality of sensors. The sensors must here satisfy the toughest demands on accuracy and reliability on the one hand, while at the same time being cost-effective and as small as possible.

The increasing use of active driver assistance systems in motor vehicles is also being accompanied by a rise in the number of sensors arranged in a front area of the motor vehicle. For example, these involve distance and/or rain sensors. However, communication means as well as position finding and object detection means are often also situated in the front area of the motor vehicle. The latter must here be arranged so as to be able to perform their function as optimally as possible, i.e., to optimally detect the environment of the motor vehicle in a largely unimpeded manner.

In light of the low number of installation sites with an open view of the motor vehicle environment and an associated limited installation space in the front area of motor vehicles, it would here appear advantageous to bundle several such sensors. Devices are already known for accommodating electronic components like sensors in motor vehicles, which can be connected to an electric power supply. The individual devices must each be separately connected with the corresponding power cables. If several sensors are inserted into an assembly opening provided for this purpose, each component must be separately connected to the power supply, which is very time-consuming, especially since no measures have been taken to enable the combined assembly of all components.

Known from publication DE 10 2008 032 400 A1 is a device for accommodating vehicle sensors, which is situated between a windshield and interior mirror of the motor vehicle.

At least one object herein is to provide a device for accommodating vehicle sensors in the front area of a motor vehicle, with the sensors configured as a single component, and which can be easily and cost-effectively mounted. In addition, other objects, desirable features and characteristics will become apparent from the subsequent summary and detailed description, and the appended claims, taken in conjunction with the accompanying drawings and this background.

### SUMMARY

An exemplary embodiment indicates a device for accommodating vehicle sensors that exhibits a housing, which in turn exhibits an installation space for accommodating sensors, communication means as well as location finding and object detection means. The device is secured to an interior vehicle mirror by means of a retaining arm. The installation space here incorporates an evaluator unit coupled with the sensors, communication means and location finding and object detection means, so as to evaluate the data from the sensors, communication means and location finding means.

The advantage to such a device is that a device for accommodating vehicle sensors in the front area of a motor vehicle can be provided that is configured as a single component, and can be easily and cost-effectively mounted. Since several sensors can be integrated into the installation space of the housing, the latter can be cost-effectively integrated into the motor vehicle, because there is no need for additional housings for sensors, in particular for location finding and object detection means, which are usually situated outside the interior of the motor vehicle. Further, this reduces the number of interfaces on the evaluator unit required for transmitting the data acquired by the sensors to a single interface, and significantly shortens the paths covered while transmitting the data, which in addition to a cost-effective construction results in a tangibly diminished bus load inside the motor vehicle. Such a device is further distinguished by great flexibility, since any number of electronic components desired can be integrated into the installation space by removing or adding sensors.

The sensors can here involve a distance sensor and/or a rain sensor and/or a sensor for monitoring a vehicle interior. As a consequence, all sensors that are usually situated in the front area of a motor vehicle can be integrated into the installation space, making it possible to economize on additional housings for the individual sensors as well as cables and interfaces inside the motor vehicle for supplying the sensors with power and transmitting the data acquired by the sensors to the evaluator unit, which further results in a simpler and more cost-effective construction.

The communication means can further be a V2X module and/or a V2V module and/or other modules for data transmission, for example a GSM (global system for mobile communications) module and/or a GPRS (general pocket radio service) module and/or a UMTS (universal mobile telecommunications system) module and/or a Bluetooth module and/or a WLAN module and/or a DRSC (dedicated short range communication) module and/or a DVB-T (digital video broadcasting-terrestrial) module. This makes it possible to significantly shorten the paths for transmitting the data of the communication means and evaluator unit, as well as the transmission paths between a V2X transceiver and a V2X antenna, for example, which reduces the necessity for cost-intensive coaxial cables, and considerably diminishes the bus load inside the motor vehicle. In turn, this results in an elevated performance and enhanced safety for the entire system.

In addition, the location finding and object detection means can be a camera and/or machine vision means and/or additional position determining modules, such as a GPS (global positioning system) module and/or a GLOS-NASS (global navigation satellite system) module and/or a COMPASS module and/or a Galileo module and/or an IRNSS (Indian regional navigation satellite system) module and/or an EGNOS (European geostationary navigation overlay service) module and/or a GAGAN (GPS aided geo augmented navigation) module and/or a WASS (wide area augmentation system) module. As a result, the paths and transmission times necessary for transmitting the data between these location finding and object detection means as well as the evaluator unit can be reduced, which leads to an expanded and improved acquisition of original data, and hence in an improved accuracy during the acquisition of objects, e.g., a lane. The improved accuracy during the acquisition of objects yields a tangibly more precise interpretation and evaluation of scenarios while using a motor vehicle, as well as an improved target acquisition.

According to an embodiment, the evaluator unit can encompass a vehicle information interface for collecting vehicle data and a digital card, which is coupled with the communication means. The evaluator unit can further be provided with vehicle information via the vehicle information interface, for example about the vehicle speed, and digital card material can be read in via the digital card, thereby further increasing the accuracy and precision of the overall system.

The evaluator unit can here exhibit a USB interface coupled with the digital card and/or a device for accommodating a SIM card coupled with the digital card. As a result, external data can be read into the digital card, making it possible to continuously update the latter and further increase the accuracy of the overall system, since up-to-date card material is made available at any time. However, other storage media are also possible for reading external data into the digital card, for example a radio interface, a USB interface or a GSM or UMTS interface.

In addition, in an embodiment, the device is supplied with power by means of a single electrical connection. The fact that an evaluator unit is additionally integrated into the installation space makes it possible to create a device which can be easily linked to a single electrical connection while having a simple structural design, and which in particular makes it easy to fuse-protect sensors linked to connection elements. When the sensors and evaluator unit are correspondingly coupled via single conductors and connection elements, all electrical components integrated into the housing can be supplied with power by means of a shared semiconductor.

In another embodiment, a motor vehicle with a device described above is provided.

The advantage to a motor vehicle encompassing a device described above is that a device for accommodating vehicle sensors can be provided in the front area of a motor vehicle, and arranged in such a way that it can be easily and cost-effectively mounted as a single component in the motor vehicle. Since several sensors can be integrated into the installation space of the housing, the latter can be easily and cost-effectively integrated into the motor vehicle, because there is no need for additional housings for sensors, in particular for location finding and object detection means, which are usually situated outside the interior of a motor vehicle. That fact that an evaluator unit is additionally provided in the installation space makes it possible to create a device which can be easily connected with a single power cable while having a simple structural design, and which in particular makes it easy to fuse-protect sensors linked to connection elements. Further, this reduces the number of interfaces on the evaluator unit required for transmitting the data acquired by the sensors to a single interface, and significantly shortens the paths covered while transmitting the data, which in addition to a cost-effective construction results in a tangibly diminished bus load inside the motor vehicle. Such a device is further distinguished by great flexibility, since any number of electronic components desired can be integrated into the installation space by removing or adding sensors.

In an embodiment, the device is connected with a windshield of the motor vehicle. The simple and flexible design of the device allows it to be joined to the windshield of the motor vehicle independently of how the pane is positioned and mounted, so that the sensors can be variably positioned, and the positioning can be easily adjusted. For example, a camera can be integrated into the installation space of the device in such a way that the inclination angle of the camera is aligned optimally, especially in terms of road composition and conditions, independently of the windshield type.

The device can here be connected with the windshield of the motor vehicle by an adhesive bond. This can take place with a method suitable for this purpose, in particular an adhesive bonding method involving the use of an adhesive layer, for example one realized by means of an adhesive film or a polyurethane-based adhesive. As a consequence, the device can be secured to the windshield in a cost-effective, very compact and easy to mount way, without detracting from its optical characteristics. Further, the targeted selection of adhesive and adhesive forces associated therewith makes it possible to reduce the forces acting on the device, so that the danger of mechanical damage can be diminished.

In addition, in an embodiment, a side of the device facing the windshield of the motor vehicle exhibits an opening in the housing in an area of the installation space accommodating a camera. The opening in the housing exposes the area of the installation space in the device for accommodating vehicle sensors in which the camera is located, wherein the opening is preferably dimensioned in such a way as not to detract from the viewing field of the camera through the housing of the device. Since the adhesive bond does not detract further from the optical appearance, the viewing field of the camera is not impaired, so that the latter can be optimally situated, for example, in terms of its inclination angle, so as to durably be optimally aligned, e.g., to supply data about road composition and/or conditions. Such openings are not required for other sensors in the front area of the motor vehicle, for example additional sensors, communication means and/or location finding and object detection means, since the windshield of a motor vehicle can transmit optical rays, and both the windshield and material of the housing, which preferably consists of a plastic material, do not influence radio signals, for example Bluetooth rays.

In an embodiment, the evaluator unit here communicates with an electronic control unit of the motor vehicle via a wired communication link.

In another embodiment, the evaluator unit further also communicates with the electronic control unit of the motor vehicle via a wireless communications link. This makes it possible to account for increased comfort demands in motor vehicles as well as a rising number of external systems, e.g., for communication or infotainment, in motor vehicles.

In a further embodiment, the sensor signals are here transmitted to the electronic control unit, which on its part instructs actuators in the motor vehicle to perform certain actions corresponding to the acquired signals. Integrating several sensors as well as an evaluator unit into the installation space of a housing of a device makes it possible to distinctly improve the evaluation of acquired data, for example in terms of accuracy, e.g., which results in reduced response times of the motor vehicle, and thus enhances driving comfort.

In summary, a device for accommodating vehicle sensors in the front area of a motor vehicle is provided herein. The device is designed in such a way as to consist of a single component, and be easily and cost-effectively integratable into a motor vehicle. For example, additional housings are no longer needed for sensors, in particular for location finding and object detection means, which are usually situated outside an interior of the motor vehicle.

In an embodiment, since an evaluator unit is additionally situated in the installation space, the accuracy of the acquired and evaluated data can be increased by significantly shortening the paths covered while transmitting the data, and hence the transmission times as well. Furthermore, all electronic components inside the housing can be supplied via a power cable, which in particular makes it easy to fuse-protect sensors hooked up to connection elements. This also results in a tangibly diminished bus load inside the motor vehicle.

Such a device is further distinguished by great flexibility, since any number of electronic components desired can be integrated into the installation space by removing or adding sensors.

### BRIEF DESCRIPTION OF THE DRAWINGS

The various embodiments will hereinafter be described in conjunction with the following drawing figures, wherein like numerals denote like elements, and wherein:

FIG. 1 is a block diagram of a device for accommodating vehicle sensors according to an exemplary embodiment;

FIG. 2 is a schematic, perspective view of a device mounted in a motor vehicle for accommodating vehicle sensors according to an exemplary embodiment, in a viewing direction toward a windshield of the motor vehicle;

FIG. 3 is a schematic, perspective view of a device mounted in a motor vehicle for accommodating vehicle sensors according to an exemplary embodiment, in a viewing direction into a vehicle interior of the motor vehicle.

### DETAILED DESCRIPTION OF THE DRAWINGS

The following detailed description is merely exemplary in nature and is not intended to limit the various embodiments or the application and uses thereof. Furthermore, there is no intention to be bound by any theory presented in the preceding background or the following detailed description.

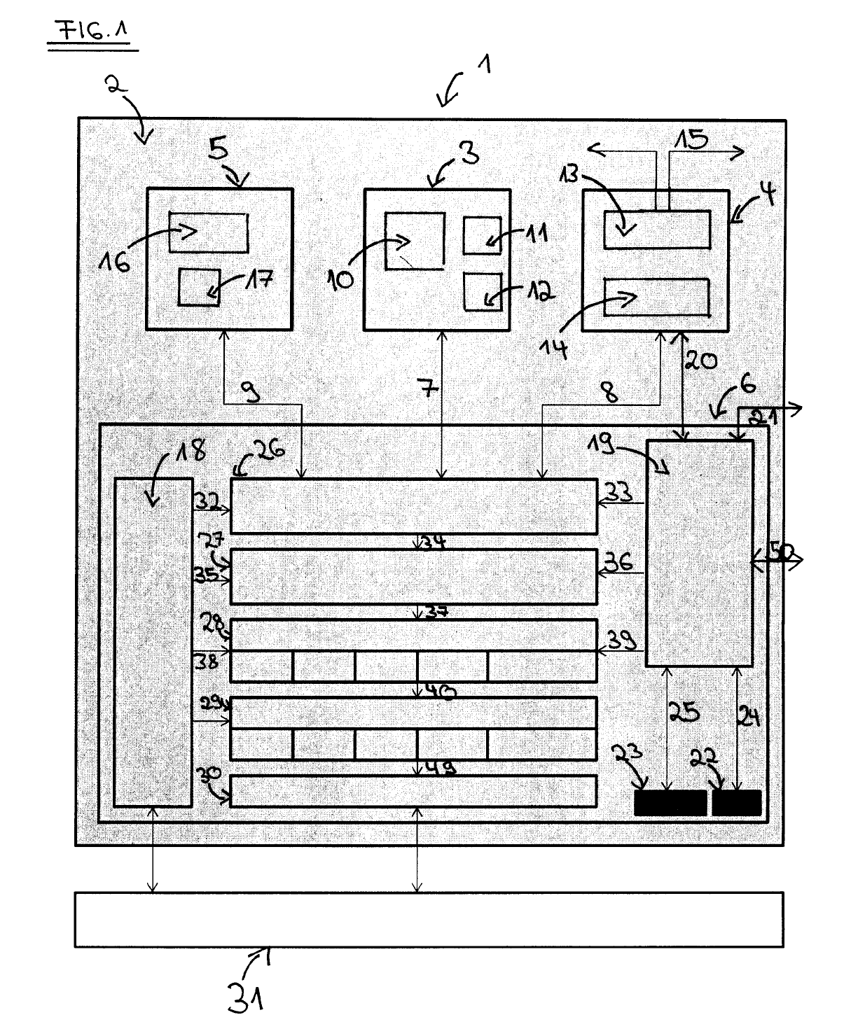

FIG. 1 shows a block diagram of a device for accommodating vehicle sensors 1 according to an exemplary embodiment.

As depicted on FIG. 1, sensors 3, communication means 4, as well as location finding and object detection means 5 are arranged in an installation space 2 of the device for accommodating vehicle sensors 1. Also arranged in the installation space 2 and coupled with the communication means 4 and location finding and object detection means 5 is an evaluator unit 6 for evaluating data from the sensors 3, the communication means 4 and the location finding and object detection means 5. The coupling between the sensors 3 and evaluator unit 6 is here symbolized by the double-headed arrow provided with reference number 7, the coupling between the communication means 4 and evaluator unit 6 by the double-headed arrow provided with reference number 8, and the coupling between the location finding and object detection means 5 and the evaluator unit 6 by the double-headed arrow provided with reference number 9.

In the exemplary embodiment on FIG. 1, the sensors 3 are comprised of a distance sensor 10, a rain sensor 11, and a vehicle interior monitoring sensor 12.

The communication means 4 involve a V2X module 13 as well as a V2V module 14. The latter encompass a communication system for communicating with external systems, for example a traffic control system, which can be any suitable wireless vehicle communication system, e.g., a DRSC system. The latter is here symbolized by the arrows provided with reference number 15. However, the communication means 4 can further be a GSM module and/or a GPRS module and/or a UMTS module and/or a Bluetooth module and/or a WLAN module and/or a DRSC module and/or a DVB-T module. The location finding and object detection means 5 shown on FIG. 1 involve a camera 16 and machine vision means 17. However, the location finding means 5 can also be a GPS module and/or GLOS-NASS module and/or a COMPASS module and/or a Galileo module and/or an IRNSS module and/or an EGNOS module and/or a GAGAN module and/or a WASS module.

As further depicted on FIG. 1, the evaluator unit 6 encompasses a vehicle information interface 18 for collecting vehicle data and a digital card 19, which is coupled with the communication means 4. The coupling between the digital card 19 and communication means 4 is here symbolized by the double-headed arrow provided with reference number 20. In addition, the digital card 19 can communicate with external devices via a Bluetooth interface. The Bluetooth interface is here symbolized by the arrow provided with reference number 21.

The evaluator unit 6 also exhibits a USB interface 22 coupled with the digital cards 19 and a device for accommodating a SIM card 23 coupled with the digital card 19. As a result, the data can be read to the digital cards and stored thereon, so that the latter are continuously updated, and up-to-date card material can be made available at any time. The coupling between the digital card 19 and USB interface 22 is here symbolized by the arrow provided with reference number 24, and the coupling between the digital card 19 and the device for accommodating a SIM card 23 by the arrow provided with reference number 25. However, other storage media are also possible for reading external data into the digital card, for example a radio interface, a USB interface or a GSM or UMTS interface. FIG. 1 shows a Bluetooth interface, which is symbolized by the arrow provided with reference number 50, between the digital card 19 and a navigation system of the motor vehicle for purposes of data exchange, so that the card material of the digital card 19 can be continuously updated.

The depicted evaluator unit 6 encompasses a data acquisition device 26, a driving situation interpreting means 27, a target acquisition means 28, a data processing device 29, as well as an interface 30 for coupling and relaying the data to an electronic control unit 31 of a motor vehicle. The data acquisition device 26 here gathers the data acquired by the sensors 3, communication means 4 and location finding and object detection means 5, and is further coupled with the vehicle information interface 18 as well as the digital card 19. The coupling of the vehicle information interface 18 with the data acquisition device 26 is here symbolized by the arrow provided with reference number 32, and the coupling between the digital card 19 and data acquisition device 26 by the arrow provided with reference number 33. The acquired data are then relayed via a first data bus 34 to driving situation interpreting means 27, so as to evaluate an existing driving situation. The driving situation interpreting means 27 is again coupled with the vehicle information interface 18, which is symbolized by the arrow provided with reference number 35, as well as with the digital card 19, as symbolized by the arrow provided with reference number 36. The data evaluated by the driving situation interpreting means 27 are relayed via a second data bus 37 to a target acquisition means 28, which is used to acquire dynamic parameters about a target, for example for distance control. The target acquisition means 28 is here again coupled with the vehicle information interface 18, as symbolized by the arrow provided with reference number 38. The target acquisition means 28 is also coupled with the digital card 19, as denoted by the arrow provided with reference number 39. The data obtained by the target acquisition means 28 are routed via a third data bus 40 to a data processing device 29, in which the latter are processed in order to set dynamic vehicle parameters for the motor vehicle based on the acquired data. These data are relayed via a fourth data bus 49 to the interface 30, and then via the latter to the electronic control unit 31, which on its part instructs actuators of the motor vehicle to perform certain actions based on the obtained data. The data can here be relayed by means of a wired or wireless communication link.

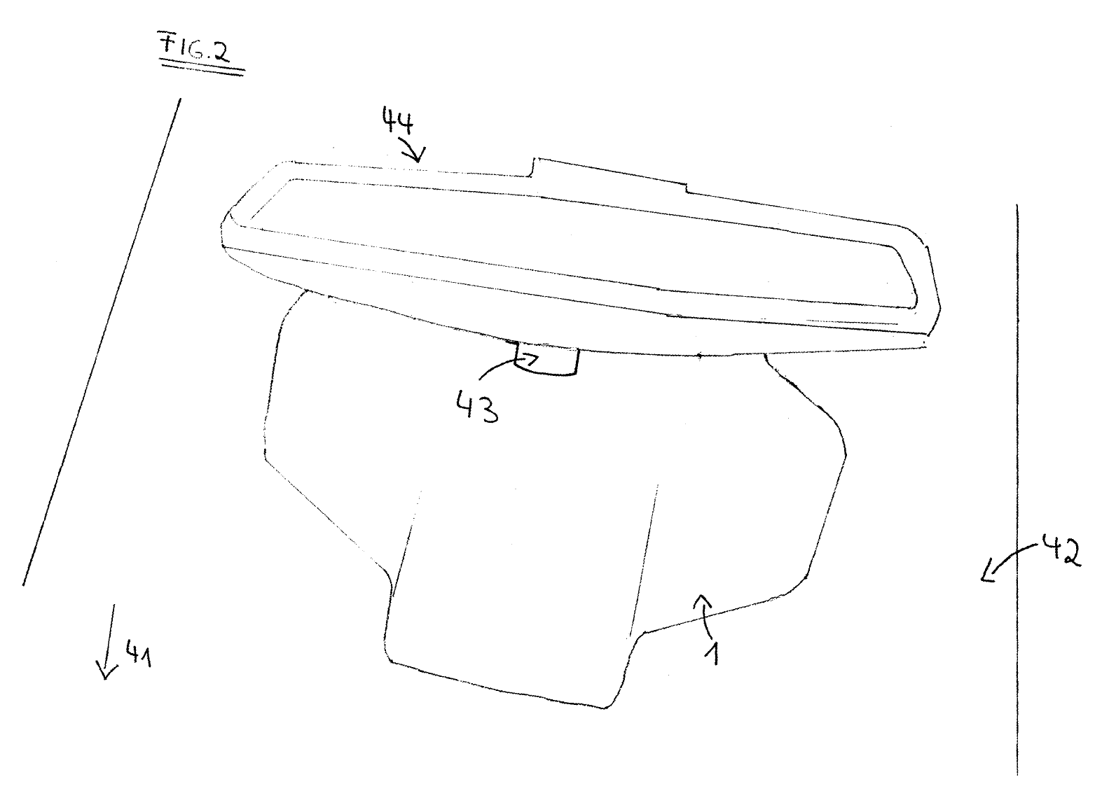

FIG. 2 presents a schematic, perspective view of a device mounted in a motor vehicle for accommodating vehicle sensors 1 according to an exemplary embodiment, in a viewing direction toward a windshield 42 of the motor vehicle. The motor vehicle is here denoted by the arrow provided with reference number 41. Elements and components with the same function or construction as on FIG. 1 are provided with the same reference numbers, and will not be separately discussed.

As FIG. 2 shows, the device 1 is here joined with an interior vehicle mirror 44 by means of a retaining arm 43.

The depicted device 1 can be supplied with power via a single electrical connection. Additionally integrating an evaluator unit 6 into the installation space 2 yields a device 1 which can be easily linked with a single electrical connection while having a simple structural design, and which in particular makes it easy to fuse-protect sensors 3 linked to connection elements.

As further evident, the device 1 in the depicted exemplary embodiment is fixedly connected with the windshield 42 of the motor vehicle.

The device 1 can here be secured to the windshield 42 of the motor vehicle by an adhesive bond not shown on FIG. 2. This can take place with a method suitable for this purpose, in particular an adhesive bonding method involving the use of an adhesive layer, for example, one realized by an adhesive film or a polyurethane-based adhesive.

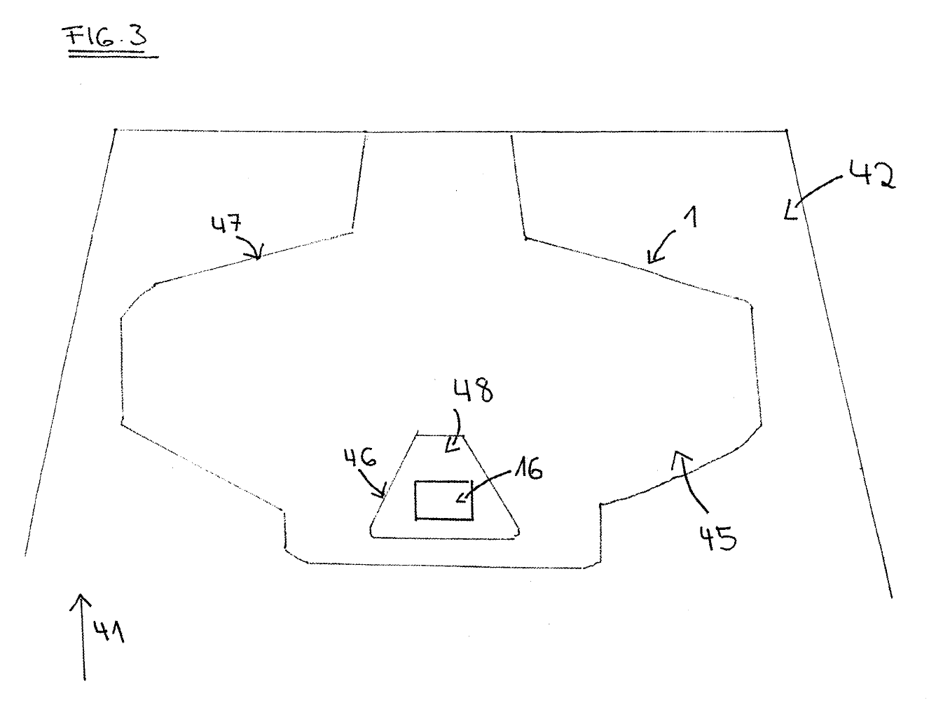

FIG. 3 presents a schematic, perspective view of a device mounted in a motor vehicle for accommodating vehicle sensors 1 according to an exemplary embodiment, in a viewing direction into a vehicle interior of the motor vehicle. Elements and components with the same function or construction as on FIGS. 1 and 2 are provided with the same reference numbers, and will not be separately discussed.

FIG. 3 shows the adhesive bond 45 between the device for accommodating vehicle sensors 1 and the windshield 42 of the motor vehicle 11. The adhesive bond 45 produces a cost-effective and easily mounted connection without influencing optical characteristics.

As further evident, a side of the device for accommodating vehicle sensors 1 facing the windshield 42 of the motor vehicle 41 exhibits an opening 46 in the housing 47. The opening 46 exposes an area 48 of the installation space 2 of the device for accommodating vehicle sensors 1 in which the camera 16 is located, wherein the opening 46 is preferably dimensioned in such a way as not to detract from the viewing field of the camera 16 through the housing 47 of the device for accommodating vehicle sensors 1. Since the adhesive bond 45 does not detract further from the optical appearance, the viewing field of the camera 16 is not impaired, so that the latter can be optimally situated, for example, in terms of its inclination angle, so as to be optimally aligned, e.g., to supply data about road composition and/or conditions. Such openings 46 are not required for other components in the front area of the motor vehicle, for example additional sensors 3, communication means 4 and/or location finding and object detection means 5, since the windshield 42 of a motor vehicle 41 can transmit optical rays, and both the windshield 42 and material of the housing 47, which preferably consists of a plastic material, do not influence radio signals, for example Bluetooth rays.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A device for accommodating vehicle sensors, the device comprising:
a sensor;
a communication means;
a location finding and object detection means; and
a housing with an installation space for accommodating the sensor, the communication means, and the location finding and object detection means;
wherein the housing is secured to an interior vehicle mirror by a retaining arm, wherein the installation space incorporates an evaluator unit coupled with the sensor, the communication means, and the location finding and object detection means so as to evaluate data from the sensor, the communication means, and the location finding and object detection means.

2. The device according to claim 1, wherein the sensor comprises a distance sensor and/or a rain sensor and/or a vehicle interior monitoring sensor.

3. The device according to claim 1, wherein the communication means comprises a V2X module and/or a V2V module and/or a GSM module and/or a GPRS module and/or a UMTS module and/or a Bluetooth module and/or a WLAN module and/or a DRSC module and/or a DVB-T module.

4. The device according to claim 1, wherein the locating finding and object detection means comprises a camera and/or machine vision means and/or a GPS module and/or GLOS-NASS module and/or a COMPASS module and/or a Galileo module and/or an IRNSS module and/or an EGNOS module and/or a GAGAN module and/or a WASS module.

5. The device according to claim 1, wherein the evaluator unit comprises a vehicle information interface for collecting vehicle data and a digital card that is coupled with the communication means.

6. The device according to claim 5, wherein the evaluator unit comprises a USB interface coupled with the digital card and/or a device for accommodating an SIM card coupled with the digital card.

7. The device according to claim 1, wherein the device is supplied with power by a single electrical connection.

8. A motor vehicle having a device for accommodating vehicle sensors, the device comprising:
a sensor;
a communication means;
a location finding and object detection means; and
a housing with an installation space for accommodating the sensor, the communication means, and the location finding and object detection means;
wherein the housing is secured to an interior vehicle mirror by a retaining arm, wherein the installation space incorporates an evaluator unit coupled with the sensor, the communication means, and the location finding and object detection means so as to evaluate data from the sensor, the communication means, and the location finding and object detection means.

9. The motor vehicle according to claim 8, wherein the device for accommodating vehicle sensors is connected to a windshield of the motor vehicle.

10. The motor vehicle according to claim 9, wherein the device for accommodating vehicle sensors is connected to the windshield of the motor vehicle by an adhesive bond.

11. The motor vehicle according to claim 9, wherein a side of the device for accommodating vehicle sensors facing the windshield of the motor vehicle comprises an opening in the housing in an area of the installation space accommodating a camera.

12. The motor vehicle according to claim 8, wherein the evaluator unit communicates with an electronic control unit of the motor vehicle via a wired communication link.

13. The motor vehicle according to claim 12, wherein the evaluator unit communicates with the electronic control unit of the motor vehicle via a wireless communication link.
